(19) United States
(12) Patent Application Publication
(10) Pub. No.: US 2023/0409400 A1
(43) Pub. Date: Dec. 21, 2023

(54) SYSTEM FOR RESOURCE ALLOCATION AND MONITORING

(71) Applicant: ZenBusiness PBC, Austin, TX (US)

(72) Inventors: Carlos Balderas, Austin, TX (US); Rafael Lopez, Austin, TX (US); Van Phuong Phu, Tucson, AZ (US); Muhammad Ashar Malik, Cypress, TX (US)

(73) Assignee: ZenBusiness PBC, Austin, TX (US)

(21) Appl. No.: 17/843,672

(22) Filed: Jun. 17, 2022

(51) Int. Cl. G06F 9/50; G06Q 20/40

(52) U.S. Cl. CPC G06F 9/5033; G06Q 20/401; G06Q 2220/00

(57) ABSTRACT

A system for operating a distributed ledger implementation for tracking and monitoring entity resources receives a resource configuration control and configures a distributed ledger that includes multiple gateway nodes to record resource transfer activity of resource rights allocations between the entity, the user account, and combinations thereof in a blockchain. The system communicates with an oracle service to verify resource transfer requirements for each resource rights allocation. The system transfers entity resources to a first party in response to the oracle service verifying that the resource transfer requirements were met by the first party and the entity. The system writes a resource transfer record into the blockchain in response to the oracle service verifying that the resource transfer requirements were met.

### BACKGROUND

Controlling the allocation and transfer of resources between organizations, between organizations and individuals, and between individuals, involves the maintenance and tracking of various constraints and requirements. Existing resource allocation and transfer systems utilize ad hoc manual procedures that scale poorly and that are slow to adapt to changing circumstances.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a resource allocation and transfer control system 100 in accordance with one embodiment.

FIG. 2 depicts a resource allocation and transfer control system 200 in accordance with one embodiment.

FIG. 3 depicts a method 300 in accordance with one embodiment.

FIG. 4 depicts a resource allocation and transfer control system 400 in accordance with one embodiment.

FIG. 5 depicts a resource allocation and transfer control system 500 in accordance with one embodiment.

FIG. 6 depicts a resource allocation and transfer control system 600 in accordance with one embodiment.

FIG. 7 depicts a resource allocation and transfer control system 700 in accordance with one embodiment.

FIG. 8 depicts a resource allocation and transfer control system 800 in accordance with one embodiment.

FIG. 9 depicts a resource allocation and transfer control system 900 in accordance with one embodiment.

FIG. 10 depicts a blockchain transaction process 1000 in accordance with one embodiment.

FIG. 11 depicts a blockchain formation 1100 in accordance with one embodiment.

FIG. 12 depicts a blockchain 1200 in accordance with one embodiment.

FIG. 13A-FIG. 13B depict embodiments of processes to form resource allocation and movement structures.

FIG. 13C-FIG. 13D depict embodiments of processes to reauthorize resource allocation and movement structures.

FIG. 14A-FIG. 14C depict a process to form a distributed resource allocation and movement structure in one embodiment.

FIG. 15 depicts a distributed resource allocation and movement structure in one embodiment.

FIG. 16 depicts a system 1600 that may be utilized to implement aspects of the methodologies and structures described herein, in accordance with one embodiment.

FIG. 17 depicts an illustrative computer system architecture 1700 that may be used to implement one or more structures and methodologies described herein.

### DETAILED DESCRIPTION

This disclosure is directed to a system and associated methodologies for operating a distributed ledger implementation for allocating, moving, and monitoring entity resources. The system comprise settings and components to allocate resources and to control the movement of resources between various authorities and stakeholders.

The system utilizes a distributed ledger comprising a plurality of gateway nodes to record resource locations and transfer activity comprising resource rights allocation between the organization, stakeholders, and combinations thereof. The distributed ledger may encode digital assets representing entity resources. The system may utilize an oracle service, information provided by the resource configuration control, to verify resource transfer requirements for each resource rights allocation.

The system may transfer entity resources to a first party in response to the oracle service verifying that the resource transfer requirements were met by the first party and the entity. The system may write a resource transfer record into the blockchain in response to the oracle service verifying that the resource transfer requirements were met by the first party and the entity.

In some configurations, the first party and the entity may be granted a multi-signature wallet configured to accept keypairs, wherein the multi-signature wallet requires approval from N-keypairs out of M-keypairs to transfer the entity resources to the first party and write the resource transfer record into the distributed ledger by way of a block submission service.

In some configurations, the first party may be granted X first party (FP)-keypairs out of M-keypairs. The entity may be granted Y entity-keypairs out of M-keypairs. The authorization authority may be granted Z authorization authority (BA)-keypairs out of M-keypairs. In this configuration a total number of M-keypairs equals X+Y+Z, and the authorization authority is part of the entity.

In some configurations, the N-keypairs may include at least one entity-keypair and at least one BA-keypair. In other configurations, the N-keypairs may not include any FP-keypairs.

In some configurations of the method, the transferring/allocating newly added entity resources may involve granting the first party and the entity a multi-signature wallet configured to accept keypairs, wherein the multi-signature wallet requires approval from N-keypairs out of M-keypairs to transfer the entity resources to the first party, or write the resource transfer record into the blockchain. The system may transfer new digital assets to the multi-signature wallet. The system may then transfer the new digital assets to the first party. The new digital assets in the multisignature wallet may be utilized to transfer the new resources from the new resource multisignature wallet to the first party multi-signature wallet. The number of new digital assets in the multisignature wallet may be reduced by the number of new entity resources transferred.

In some configurations, the entity digital assets may be updated in the distributed ledger to reflect the new resource distribution. In some configurations, the new digital assets may not be part of the entity digital assets in the distributed ledger.

Various terms are utilized herein and should be accorded their ordinary meaning in the art, and in view of the following definitions.

“(BA)-keypair” refers to a “board authority” keypair assigned to a member of the authorization authority for casting a vote for approving, rejecting, or confirming resource transfer transactions between the entity and a user account or between user accounts.

“(FP)-keypair” refers to a “first party” keypair assigned to a member of the entity, or someone seeking to become a member of the entity, for casting a vote for approving, rejecting, or confirming resource transfer transactions between the entity and a user account or between user accounts.

“2-of-3 multisignature wallet” refers to requiring at least two keys out of 3 to authorize a digital asset transaction. Crypto wallets are digital and physical, offline and online methods that rely on public key cryptography to allow users to send and receive digital assets securely across a network.

“Accidental fork” refers to a branching in the chain that happens when two or more miners find a block at nearly the same time. The fork is resolved when subsequent block(s) are added and one of the chains becomes longer than the alternative(s). The network abandons the blocks that are not in the longest chain (they are called orphaned blocks).

“Authorization authority” refers to a plurality of entities that collectively controls management of an entity. An authorization authority may comprise individuals and/or logic agents responsive to smart contract settings.

“Block submission service” refers to a service for recording resource transfer records to the blockchain of a distributed ledger following approval of a resource transfer transaction

“Block time” refers to the average time it takes for the network to generate one extra block in the blockchain.

“Blockchain” refers to is a growing list of records, called blocks, that are linked using cryptography. Each block contains a cryptographic hash of the previous block, a timestamp, and transaction data (generally represented as a Merkle tree).

By design, a blockchain is resistant to modification of the data. It is an open, distributed ledger that can record transactions between two parties efficiently and in a verifiable and permanent way. For use as a distributed ledger, a blockchain is typically managed by a peer-to-peer network collectively adhering to a protocol for inter-node communication and validating new blocks. Blockchains may be considered secure by design and exemplify a distributed computing system with high Byzantine fault tolerance. Decentralized consensus has therefore been claimed with a blockchain.

“Digital assets” refers to a digital representation of a resource of value, for which ownership is verified and recorded on a distributed ledger. Digital assets may for example comprise account balances, cryptocurrencies, crypto assets, virtual currencies, and crypto tokens. Some digital assets may represent stakes in a particular physical asset, project, or organization. Others are intended to be currencies, like Bitcoin, and do not represent a stake in a particular organization.

“Entity authorization authority” refers to a member of the board of directors.

“Entity keypair” refers to keypair assigned to the stakeholders in a resource-generating organization.

“Entity resources” refers to resources controlled by or generated by an organization.

“Hard fork” refers to a rule change such that the software validating blocks according to the old rules will detect the blocks produced according to the new rules as invalid.

“M-keypairs” refers to total number of keypairs utilized in a keypair voting authentication scheme.

“Multi-signature wallet” refers to for example, the request from a multi-signature wallet would be similar to “function submit Transaction(address destination, unit value, bytes data)”

“N-keypairs” refers to number of keypairs required in a keypair authentication scheme to approve a transaction.

“New digital assets” refers to tokenized resources transferable between parties representing a new distribution of rights in entity resources.

“New entity resources” refers to unassigned rights in entity resources transferable to eligible parties.

“Oracle service” refers to a third party application service monitoring smart contracts written into the creation of a block in a blockchain. The oracle service may interface with other applications through an application program interface to monitor the conditions of a smart contract and report the results to the ledger as a source of truth. CARTA, LLC is an example of an oracle service.

“Orphaned blocks” refers to blocks in an abandoned fork.

“Private blockchain” refers to (i.e., permissioned blockchains) blockchains that use an access control layer to govern who has access to the network. In contrast to public blockchain networks, validators on private blockchain networks are vetted by the network owner. They do not rely on anonymous nodes to validate transactions nor do they benefit from the network effect. Private blockchains can also go by the name of ‘consortium’ or ‘hybrid’ blockchains.

“Resource configuration control” refers to control signal communicated to configured authorization points to alter an entity's resource distribution or pool of available resources.

“Resource rights allocation” refers to allocation of participation rights in entity resources among stakeholders of an organization, project, or physical resource.

“Resource transfer record” refers to transactional record recording movement of resources between eligible parties written to the blockchain of a distributed ledger.

“Smart contract” refers to smart contracts are contracts that can be partially or fully executed or enforced without human interaction. One of the main objectives of a smart contract is automated escrow. The IMF believes smart contracts based on blockchain technology could reduce moral hazards and optimize the use of contracts in general. Due to the lack of widespread use their legal status is unclear. A blockchain implementation that enables the coding of contracts that execute when specified conditions are met. A blockchain smart contract is enabled by logic that defines and executes an agreement. For example, Ethereum Solidity is an open-source blockchain project that was built specifically to realize this possibility by implementing a Turing-complete programming language capability to implement smart contracts.

“Soft fork” refers to a change of rules that creates blocks recognized as valid by the old software, i.e. it is backwards-compatible.

“Weighted keypair” refers to a scenario where combinations of the number of keypairs (N) and the total number of keypairs (M) have been modified so that a larger percentage of the M is given to board and/or entity shareholders. N represents the number of keypairs required for vote authentication of a transaction and the M represents the total keypairs in the authentication scheme.

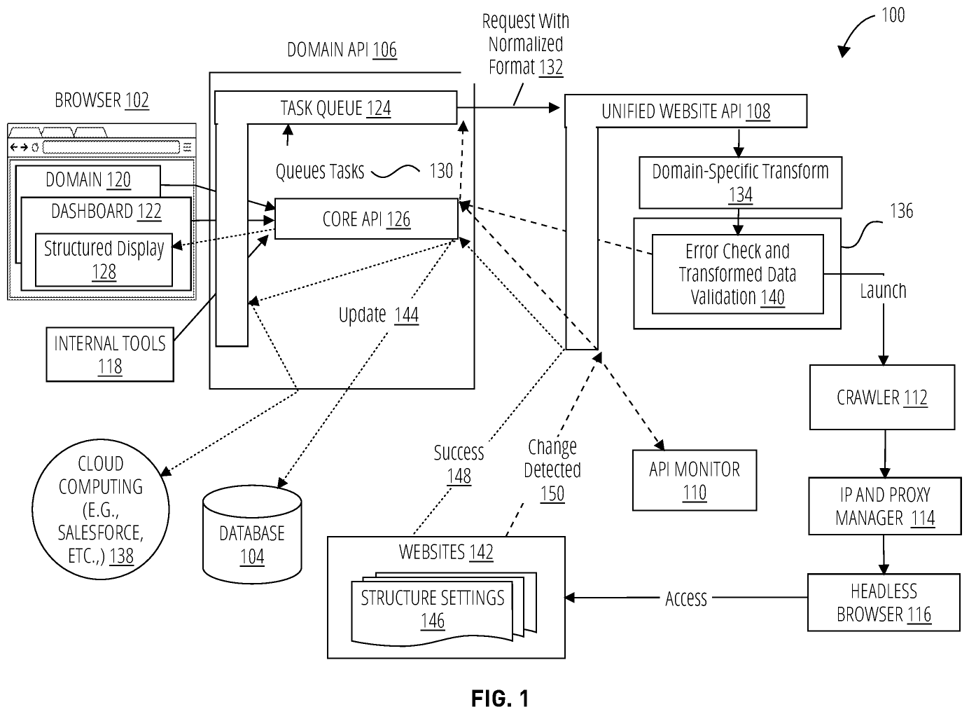

Referencing FIG. 1, a resource allocation and transfer control system 100 comprises a browser 102, a database 104, a domain API 106, a unified website API 108, an API monitor 110, a crawler 112, an IP and proxy manager 114, a headless browser 116, and internal tools 118.

The browser 102 may access a domain 120 hosting or interfacing with the resource allocation and transfer control system 100 and may present a dashboard 122 for configuring, controlling, and monitoring entity resources via the resource allocation and transfer control system 100. The domain 120 and the dashboard 122 communicate with the domain API 106. The domain API 106 receives controls from the domain 120, the dashboard 122, and internal tools 118. The domain API 106 comprises a task queue 124 and a core API 126. Configuration controls from the domain 120, the dashboard 122 and the internal tools 118 transit through the domain API 106 to a core API 126. The dashboard 122 may include a structured display 128 of the system structure and/or the entity's resource allocations.

Configuration controls are communicated to the core API 126 which then communicates the controls to the task queue 124, which queues tasks 130. The tasks are tasks associated with the formation and management of the resource allocation and control structure to form. The task queue 124 responds by communicating a request 132 to a unified website API 108. The unified website API 108 generates a domain-specific transform 134 required by a particular domain and operates a validator 136 to confirm the structure passes domain-specific constraints. In some configurations, outputs from the domain API 106 may be communicated to a cloud computing system 138 to perform further processing.

The validator 136 performs an error check and validation 140 on the configuration controls. Once validation passes, the unified website API 108 launches a crawler 112, an IP and proxy manager 114, and a headless browser 116 to access websites 142. The IP and proxy manager 114 provides IP rotation and proxy management services to circumvent IP block lists associated with accessing the websites 142. The headless browser 116 may provide a command line interface for accessing the websites 142, reducing the resource requirements associated with access the websites 142. The system may apply an update control 144 to the database 104 reflecting the validated configuration controls.

The websites 142 accept and register the formation control structure 146. Depending on the success of the submission, the system may respond back to the unified website API 108 with a success control 148 or a change detected control 150.

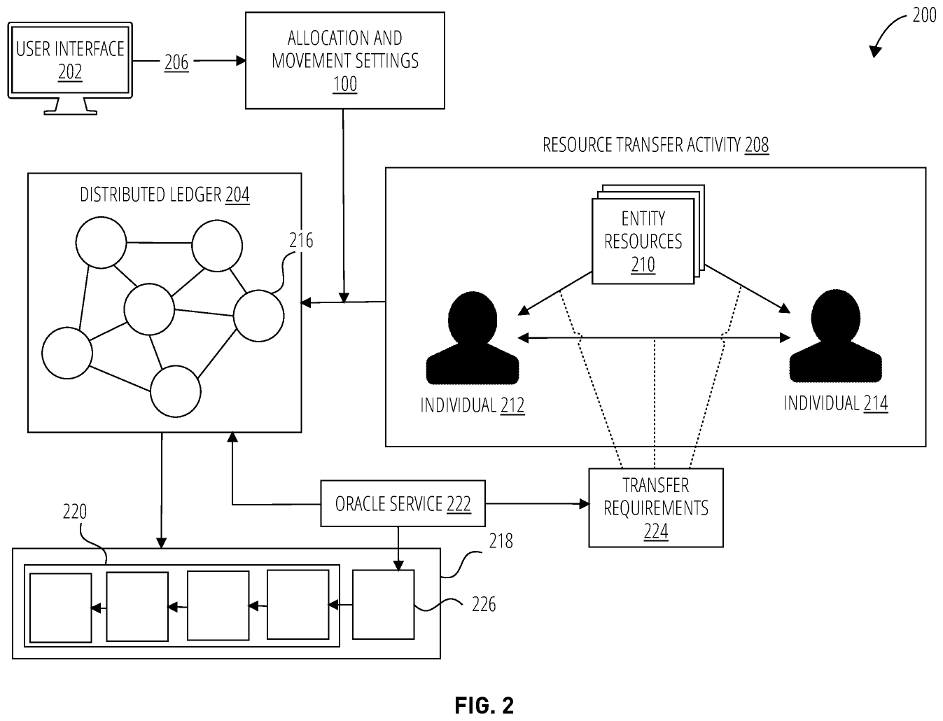

Referencing FIG. 2, a resource allocation and transfer control system 200 includes a user interface 202, a resource allocation and transfer control system 100, and a distributed ledger 204. The user interface 202 configures a resource allocation and transfer control system 100 with a resource configuration control 206 to track resource transfer activity 208 comprising entity resources 210 being transferred between the entity (e.g., business entity), user accounts (e.g., individual 212, individual 214)), and combinations thereof. The resource allocation and transfer control system 100 records the resource transfer activity 208 in a distributed ledger 204 comprising a plurality of interconnected gateway nodes 216 each comprising a blockchain 218 record comprising entity records 220. The resource allocation and transfer control system 100 may communicate with an oracle service 222 as a third party service to validate that resource transfer requirements 224 have been met before a resource transfer record 226 is written to the blockchain 218 as entity records 220. In some configurations, the resource transfer requirements 224 may be encoded on the blockchain as a smart contract.

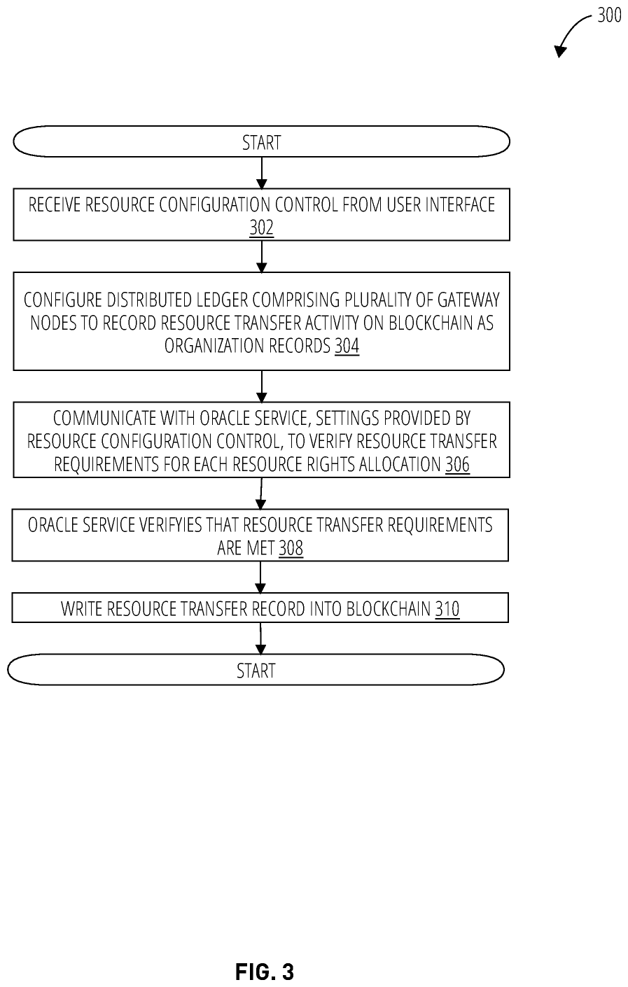

The resource allocation and transfer control system 200 may be operated in accordance with the process described in FIG. 3.

Referencing the method 300 of FIG. 3, in block 302, the method 300 receives a resource configuration control at an entity formation and management system from a user interface. In block 304, the method 300 configures a distributed ledger comprising a plurality of gateway nodes on a blockchain to record resource transfer activity comprising resource rights allocation between an entity, a user account, and combinations thereof. In block 306, the method 300 communicates information provided by the resource configuration control to an oracle service to verify resource transfer requirements for each resource rights allocation. In block 308, the method 300 communicates with the oracle service to verify that the resource transfer requirements were met by both parties. In block 310, the method 300 writes a resource transfer record into the blockchain.

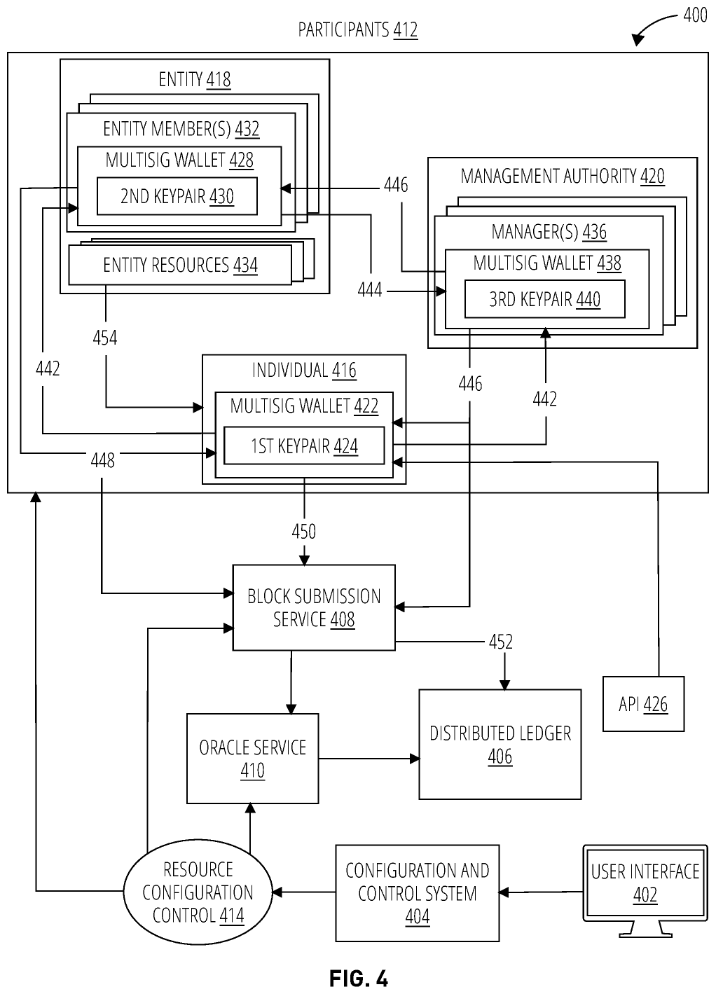

FIG. 4 depicts a resource allocation and transfer control system 400 in accordance with one embodiment. The resource allocation and transfer control system 400 comprises a user interface 402, a configuration and control system 404, a distributed ledger 406, a block submission service 408, an oracle service 410, and participants 412. The configuration and control system 404 receives a request from a user interface 402 to make a change the entity resource allocation. The configuration and control system 404 includes information about an entity's resource allocations. The resource configuration control 414 comprises a request to change the resource allocation of the entity associated with the configuration and control system 404. The resource configuration control 414 may for example comprise a resource transfer request between a first party (individual 416) and the entity 418.

The resource configuration control 414 is communicated to participants 412 of the resource transfer request. These include an entity 418, a management authority 420, and a first party (individual 416). Each participant includes a multi-signature wallet to verify, confirm, or dispute resource transfer activity through authorization rights associated with a set of keypairs.

The multi-signature wallets may be configured as a ⅔ authorization right multi-signature wallet with a first keypair given to the individual 416, a second keypair given to the entity 418, and a third key pair given to the management authority 420. The keypairs may be utilized to confirm the identity of the participants and as authorizations confirming the transfer of resources between the entity and an individual as well as between different individuals.

In some configurations, the entity 418 may create multiple wallets designed to provide different types and levels of authorization rights for the transfer of different types of resources.

The individual 416 may be associated with a multi-signature wallet 422 comprising a first party keypair 424 that was generated through an application programming interface (API 426). The API 426 may be utilized to constrain the creation of multi-signature wallets and limit participants in the resource allocation and transfer control system.

The entity 418 is associated with a multi-signature wallet 428 with an entity keypair 430 that may be operated by at least one entity member 432. The entity member 432 may represent authorities of the formed entity (human or artificial intelligence agents) responsible for the entity resources 434. The entity 418 may operate with a management authority 420 comprising at least one manager 436 for the entity 418. The manager 436 may be associated with a multi-signature wallet 438 with an authorization authority keypair 440 that may be utilized to submit an authorization confirming or disputing resource transfers between the entity 418 and the individual 416 or between individuals.

The resource configuration control 414 comprises a request from the individual 416 for entity resources 434. The multi-signature wallet 422 of the individual 416 may communicate a transfer request 442 to the multi-signature wallet 428 of entity 418 and the multi-signature wallet 438 of the management authority 420. At least one entity member 432 may accept the conditions of the resource transfer and approve it through the entity keypair 430. The at least one entity member 432 may then communicate an approval request 444 to the management authority 420. The at least one manager 436 may respond to the approval request 444 with a confirmation 446 communicated to the multi-signature wallet 428 and the multi-signature wallet 422, of the entity 418 and the individual 416, respectively. After receiving the confirmation 446 the entity 418 may communicate a confirmation 448 to the multi-signature wallet 422 of the individual 416.

The confirmation 446, confirmation 448, and confirmation 450 from the multi-signature wallet 422 of the individual 416 may then be communicated to a block submission service 408 to generate a resource transfer record 452 to be included in the distributed ledger 406. Block submission service 408 may notify an oracle service 410 of the resource transfer record 452, whereafter the oracle service 410 determines if external conditions of the resource transfer have been met by all parties before the resource transfer record 452 is recorded to the distributed ledger 406. With the resource transfer record 452 recorded to the distributed ledger 406, a resource transfer 454 occurs moving the entity resources 434 to the individual 416. In some configurations, the resource transfer 454 is recorded in the distributed ledger 406 as a resource transfer record 452 without physical transfer of digital assets between the entity 418 and the individual 416. The oracle service 410 may also record its verification to the distributed ledger 406 as a source of truth.

In some configurations, the distributed ledger 406 may be configured to operate utilizing technologies such as colored coins, RGB on Lightning Network, Ethereum, etc., but is not limited thereto.

In one scenario, an individual may want to become a new stakeholder in an entity. In this scenario, existing resources may be transferred to the individual without the entity generating or obtaining new resources. The individual may request/pay for transferred resources and be granted a keypair (first keypair) to submit the resource transfer request. The entity receives the request and approves the transaction utilizing its keypair (second keypair). The authorization authority then reviews the transfer request and approves or declines the request with its keypair (third keypair). In this situation, a transfer may be completed using two keypairs and one of those keypairs may be (but is not required to be) the first keypair.

In another scenario, an individual may want to become a new stakeholder and new resources may need to be obtained or generated by the entity to meet the request. In this scenario, the individual may request/pay for transferred resources and be granted a keypair (first keypair) to submit the resource transfer request. The entity may approve the transaction utilizing its keypair (second keypair). The authorization authority may then submit approval if necessary to generate or obtain new resources utilizing its keypair (third keypair). In this situation, a transfer may be completed using two keypairs, but one of those keypairs must be the third keypair.

In another scenario, an individual may want to become a new stakeholder and may utilize an external event API. The individual may request/pay for transferred resources and be granted a keypair (first keypair) to submit the resource transfer request. The entity may approve the transaction utilizing its keypair (second keypair). The authorization authority may be required to approve the transaction before the resources are transferred utilizing its keypair (third keypair). In this scenario, a transfer may be completed only if the second keypair and the third keypair approve.

In another scenario, an individual may want to become a new stakeholder and new resources may need to be issued, but the authorization authority utilizes weighted keypairs. The individual may request/pay for transferred resources and be is granted a keypair (first keypair) to submit the resource transfer request. The entity may approve the transaction utilizing its keypair (second keypair). The authorization authority's approval may then be necessary to generate or obtain new resources, utilizing multiple keypairs with different authorization weights. In this scenario, a transfer may be completed using keypairs comprising a majority of the authorization weight.

Another scenario may involve a resource transfer that may result in a change of control over the entire resource pool or a majority of it. In this scenario, weighted keypairs may also be utilized. An individual or other entity may request/pay for transferred resources and be granted a keypair (first keypair) to submit the resource transfer request. The entity may approve the transaction that includes the shareholders' weighted keypairs. The authorization authority's approval may then be necessary and a transfer may be completed using two keypairs and both of those keypairs must comprise a majority of the weighted keypair authority.

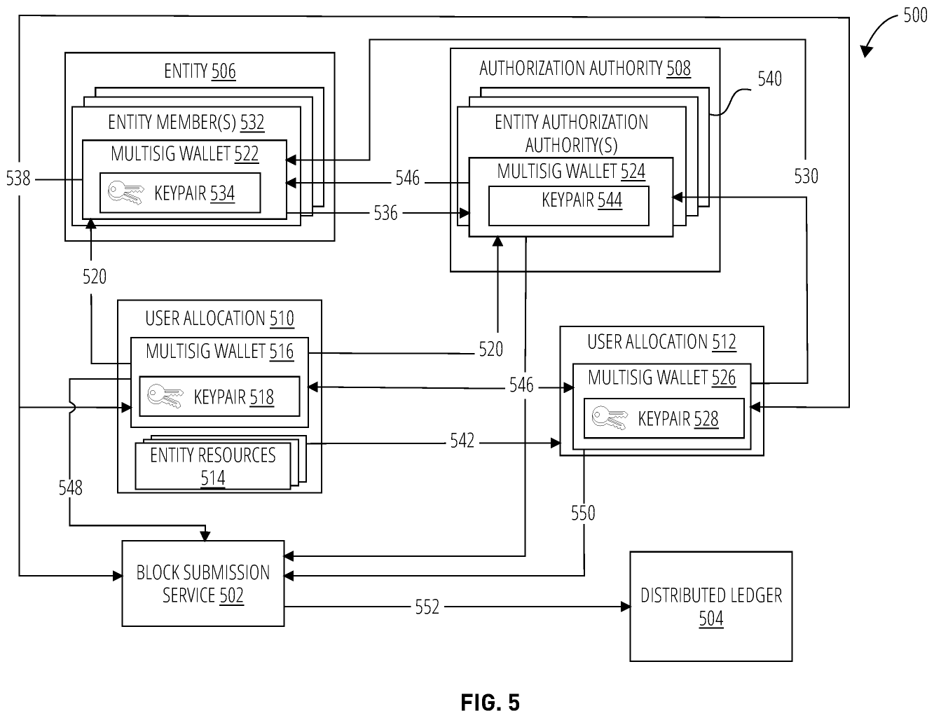

FIG. 5 depicts a resource allocation and transfer control system 500 in accordance with one embodiment. The resource allocation and transfer control system 500 comprises a block submission service 502, a distributed ledger 504, an entity 506, an authorization authority 508, a user allocation 510, and a user allocation 512.

In the resource allocation and transfer control system 500, a resource configuration control is received for transferring entity resources 514 from the user allocation 510 to the user allocation 512. A control point of the user allocation 510, utilizing the multi-signature wallet 516 with the keypair 518, initiates a transfer request 520 to the multi-signature wallets of the entity 506 and the authorization authority 508, multi-signature wallet 522 and multi-signature wallet 524, respectively. Similarly, a control point of the user allocation 512, utilizing the multi-signature wallet 526 with the keypair 528, initiates a transfer request 530 to the multi-signature wallets of the entity 506 and the authorization authority 508, multi-signature wallet 522 and multi-signature wallet 524, respectively.

At least one entity member 532 of the entity 506 confirms and authorizes the transfer request 520 utilizing the entity keypair 534 to authorize the transaction 536 of the transfer request 520. Following its authorization, the entity 506 may communicate a confirmation 538 to the controllers of the multi-signature wallets of the user allocation 510 and the user allocation 512, as well as the block submission service 502.

At least one entity authorization authority 540 receives the transfer request 520. The at least one entity authorization authority 540 may approve of the resource transfer 542 between the user allocation 510 and the user allocation 512 by authorizing the transaction via their authorization authority keypair 544. The authorization authority 508 may communicate a confirmation 546 to the controllers of the multi-signature wallets of the entity 506, the user allocation 510, and the user allocation 512, as well as the block submission service 502.

The user allocation 510 and the user allocation 512 may communicate confirmations (confirmation 548 and confirmation 550) to the block submission service 502, awaiting approval from the entity 506 and the authorization authority 508.

With authorization received from all participants in the transaction, the block submission service 502 writes a resource transfer record 552 to the distributed ledger 504, indicating a resource transfer 542 of entity resources 514 from the user allocation 510 to the user allocation 512.

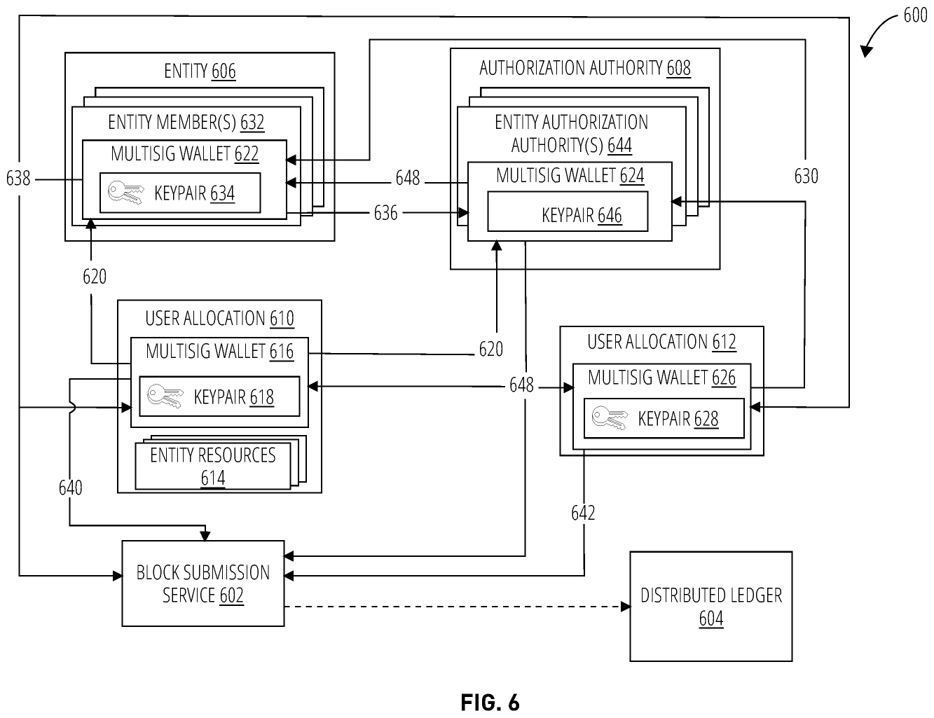

FIG. 6 depicts a resource allocation and transfer control system 600 in accordance with one embodiment. The resource allocation and transfer control system 600 comprises a block submission service 602, a distributed ledger 604, an entity 606, an authorization authority 608, a user allocation 610, and a user allocation 612.

A resource configuration control is received for transferring entity resources 614 from the user allocation 610 to the user allocation 612. A control point of the user allocation 610, utilizing the multi-signature wallet 616 with the keypair 618, initiates a transfer request 620 to the multi-signature wallets of the entity 606 and the authorization authority 608, multi-signature wallet 622 and multi-signature wallet 624, respectively. Similarly, a control point of the user allocation 612, utilizing the multi-signature wallet 626 with the keypair 628, initiates a transfer request 630 to the multi-signature wallets of the entity 606 and the authorization authority 608, multi-signature wallet 622 and multi-signature wallet 624, respectively.

At least one entity member 632 of the entity 606 may utilize the entity keypair 634 to authorize the transaction 636 of the transfer request 620. Upon authorization, the entity 606 may communicate a confirmation 638 to the controllers of the multi-signature wallets of the user allocation 610 and the user allocation 612, as well as the block submission service 602. The user allocation 610 and the user allocation 612 may communicate confirmations (confirmation 640 and confirmation 642) to the block submission service 602 while awaiting approval from the entity 606 and the authorization authority 608.

In this example, at least one entity authorization authority 644 comprising the authorization authority keypair 646 receives the transfer request 620 and declines to authorize the resource transfer between the user allocation 610 and the user allocation 612. The authorization authority 608 may then communicate a rejection 648 to the controllers of the multi-signature wallets of the entity 606, the user allocation 610, and the user allocation 612, as well as the block submission service 602.

Although confirmations were received from the entity 606, the user allocation 610, and the user allocation 612, the resource transfer is configured with a ⅔ authorization requiring both the entity 606 and the authorization authority 608 to approve of a transfer. Because the authorization authority 608 rejected the resource transfer between the user allocation 610 and the user allocation 612, the block submission service 602 does not generate a resource transfer record for the distributed ledger 604

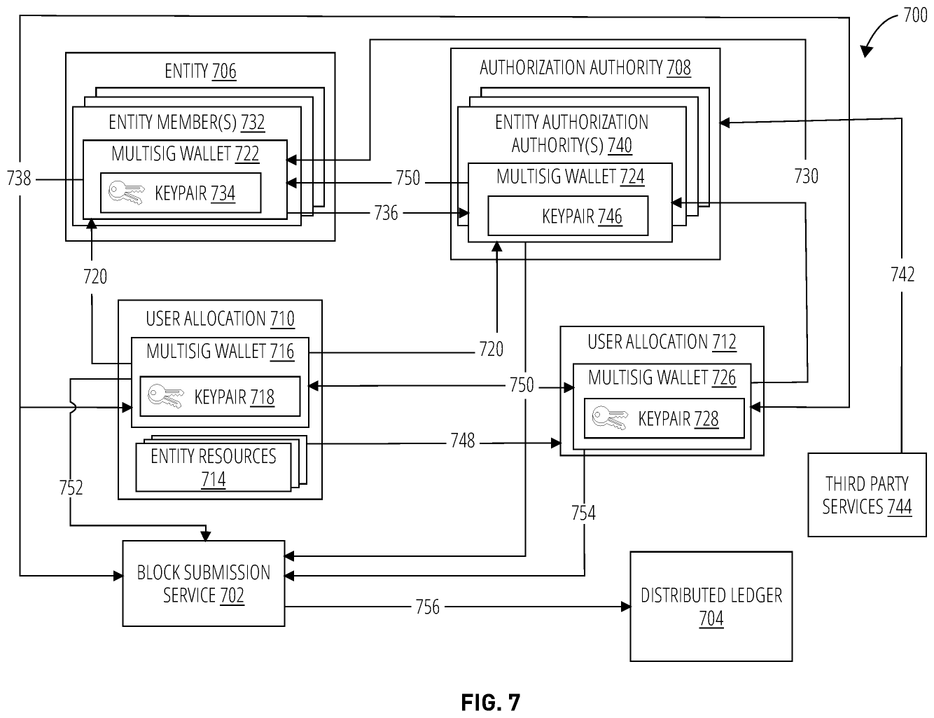

FIG. 7 depicts a resource allocation and transfer control system 700 in accordance with one embodiment. The resource allocation and transfer control system 700 comprises a block submission service 702, a distributed ledger 704, an entity 706, an authorization authority 708, a user allocation 710, and a user allocation 712. In the resource allocation and transfer control system 700, a resource configuration control initiates transfer of entity resources 714 from the user allocation 710 to the user allocation 712.

A control point for the user allocation 710, utilizing the multi-signature wallet 716 with the keypair 718, provides a transfer request 720 to the multi-signature wallets of the entity 706 and the authorization authority 708, multi-signature wallet 722 and multi-signature wallet 724, respectively. Similarly, a control point for the user allocation 712, utilizing the multi-signature wallet 726 with the keypair 728, declares via the API, a transfer request 730 to the multi-signature wallets of the entity 706 and the authorization authority 708, multi-signature wallet 722 and multi-signature wallet 724, respectively.

At least one entity member 732 of the entity 706 utilizes the entity keypair 734 to authorize the transaction 736. The entity 706 may communicate a confirmation 738 to the controllers of the multi-signature wallets of the user allocation 710 and the user allocation 712, as well as the block submission service 702, following its authorization.

At least one entity authorization authority 740 receives the transfer request 720. The at least one entity authorization authority 740 may receive additional transfer information 742 from third party services 744 (e.g., regulatory authorities) and may act on this information when submitting a response. In some configurations, the entity 706 may also receive the transfer information 742 from the third party services 744 before submitting their response. If the at least one entity authorization authority 740 determines there are no restrictions, it may utilize its authorization authority keypair 746 to authorize the resource transfer 748 between the user allocation 710 and the user allocation 712. The authorization authority 708 may communicate a confirmation 750 to the controllers of the multi-signature wallets of the entity 706, the user allocation 710, and the user allocation 712, as well as the block submission service 702.

The user allocation 710 and the user allocation 712 may communicate confirmations (confirmation 752 and confirmation 754) from their control points to the block submission service 702, awaiting approval from the entity 706 and the authorization authority 708.

With authorizations received from all participants, the block submission service 702 writes a resource transfer record 756 to the distributed ledger 704 indicating a resource transfer 748 of entity resources 714 from the user allocation 710 to the user allocation 712.

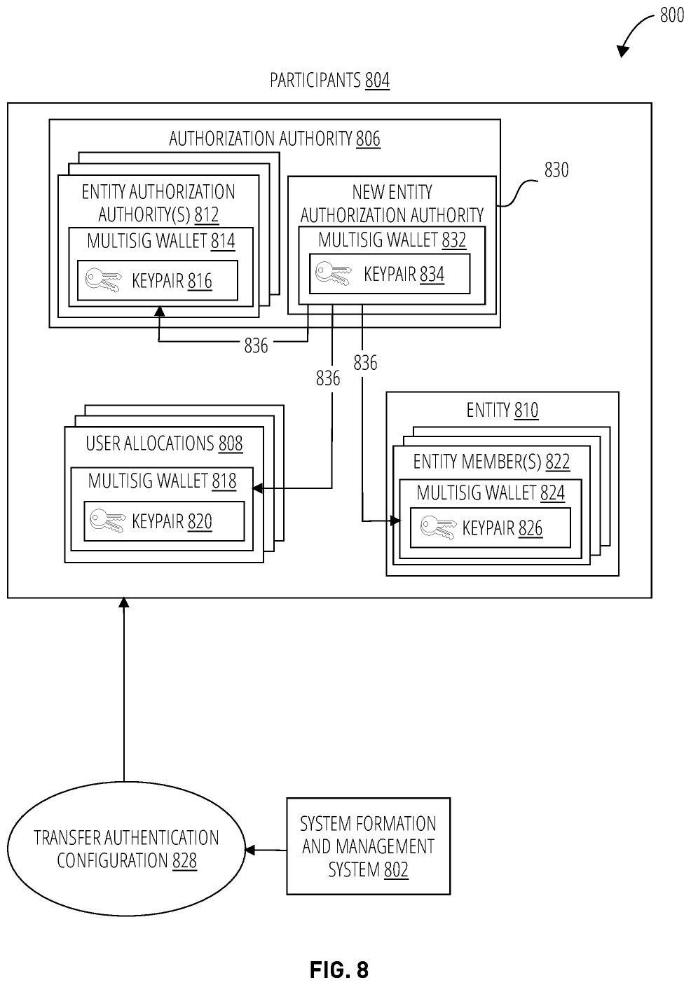

FIG. 8 depicts a resource allocation and transfer control system 800 in accordance with one embodiment. The resource allocation and transfer control system 800 comprises a system formation and management system 802 and participants 804 comprising an authorization authority 806, user allocations 808, and an entity 810. The authorization authority 806 comprises at least one entity authorization authority 812 with access to a multi-signature wallet 814 comprising an authorization authority keypair 816. The user allocations 808 comprise a multi-signature wallet 818 with a keypair 820. The entity 810 comprises at least one entity member 822 with a multi-signature wallet 824 with an entity keypair 826.

A transfer authentication configuration 828 is received from a system formation and management system 802 configuring the authorization authority 806 with a new entity authorization authority 830 comprising a multi-signature wallet 832 with a new authorization authority keypair 834. The addition of the new entity authorization authority 830 changes the authorization requirements for approving transfers as the keypair authentication goes from ⅔ authentication scheme to a ¾ authentication scheme. As the transfer requirements change with the creation of the new multi-signature wallet 832 and new authorization authority keypair 834, updated transfer requirements 836 are declared from an API, from the multi-signature wallet 832 to the multi-signature wallets of the at least one entity authorization authority 812, the user allocations 808, and the entity 810 to ensure that requirements are met before a transfer is processed.

In certain embodiments, keypair may not be weighted, however the authentication scheme may be modified to reflect changes in the organization. One authentication scheme is a 2-of-3 authentication; however, organizations may generally implement N-of-M rules, where the N represents the number of keypairs required for authentication of a transaction and the M represents the total keypairs in the authentication scheme.

To maintain authority over the resource transfer process, the authentication scheme may be modified such that the N keypairs and the M keypair are skewed so that a larger percentage of the M are given to certain entity operational authorities. It may be beneficial to keep the N-keypair number low enough such that it serves its day to day function of approving transfer requests while also having enough keypair authorizations to represent the authority of stakeholders more broadly.

The authentication scheme may be modified with a longer authentication scheme, for example (1 of user keypair) & (1 of entity keypair) & (1 of authorization authority keypair) & (1 of authorization authority keypair) & (1 of authorization authority keypair). This configuration forms a larger M keypair value and may function similar to a weighted key pair scheme.

Another authentication scheme weights the authorization authority keypairs higher relative to the entity keypairs, for example (1 of user keypair) & (1 of entity keypair+X amount of the total authorization authority keypairs) & (1 of authorization authority keypair). In this configuration, some key pairs of the authorization authority are counted twice. This mechanism may be viewed as a weight redistribution but may function to override particular authorizations from the keypair groups.

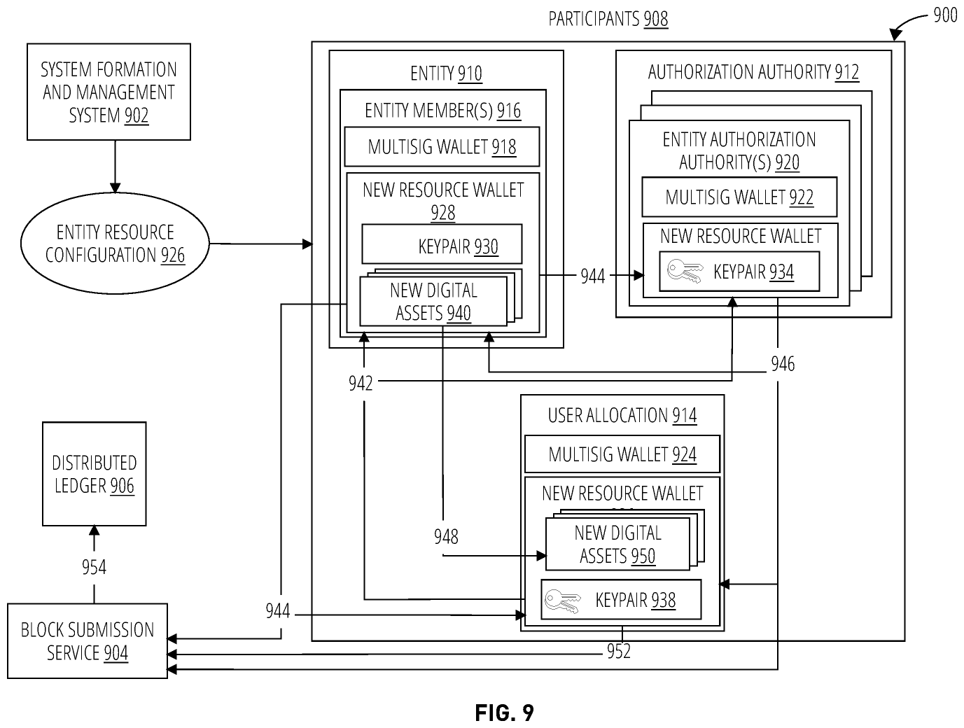

FIG. 9 depicts a resource allocation and transfer control system 900 in accordance with one embodiment. The resource allocation and transfer control system 900 comprises a system formation and management system 902, a block submission service 904, a distributed ledger 906, and participants 908 comprising an entity 910, an authorization authority 912, and a user allocation 914. The entity 910 comprises at least one entity member 916 with a multi-signature wallet 918. The authorization authority 912 comprises an at least one entity authorization authority 920 with a multi-signature wallet 922. The user allocation 914 comprises a multi-signature wallet 924.

In this example, the participants 908 receive an entity resource configuration 926 from the system formation and management system 902 that configures the participants 908 with new multi-signature wallets for approving, transferring, and receiving new digital assets from the entity. The entity 910 receives a new resource multi-signature wallet 928 with an entity keypair 930. The authorization authority 912 receives a new resource multi-signature wallet 932 with an authorization authority keypair 934. The user allocation 914 receives a new resource multi-signature wallet 936 with a user keypair 938.

The entity resource configuration 926 generates new digital assets 940 representing entity resources or new entity resources. The new digital assets 940 may be transferrable to the new resource multi-signature wallet 936 of a user allocation 914. The user allocation 914 initiates a transfer request 942 to the new resource multi-signature wallets of the entity 910 and the authorization authority 912. The entity 910 may authorize the transaction 944 to the new resource multi-signature wallet 928 to the new resource multi-signature wallet 932 of the authorization authority 912 and the new resource multi-signature wallet 936 of the user allocation 914, as well as the block submission service 904. The authorization authority 912 may authorize the transaction 946 to the new resource multi-signature wallet 928 of the entity 910 and the new resource multi-signature wallet 936 of the user allocation 914, as well as to the block submission service 904. With authorization from the authorization authority 912 and the entity 910, a new resource transfer 948 may be processed such that new digital assets 950 are stored in the new resource multi-signature wallet 936 of the user allocation 914. The user allocation 914 may authorize the transaction 952 to the block submission service 904. The block submission service 904 may then write a resource transfer record 954 to the distributed ledger 906.

In some embodiments, the resource allocation and transfer control system 900 may populate a new resource multi-signature wallet with new digital assets. The resource allocation and transfer control system 900 may transfer the new digital assets 940 to a first party (user allocation 914). In this configuration, the new digital assets 940 in the new resource multi-signature wallet 928 are used to transfer new entity resources from the new resource multi-signature wallet 928 to the new resource multi-signature wallet 936 of the first party. In some instances, the level of new digital assets in the new resource multi-signature wallet is reduced by an amount of new entity resources transferred to the new resource multi-signature wallet 936. In some instances, the new digital assets are not part of the entity digital assets in the distributed ledger. The block submission service 904 may update the entity digital assets in the distributed ledger to reflect the new resource distribution.

In one embodiment, new digital assets may be formed by minting a larger than necessary number of crypto-coins that may be stored in a digital wallet. The minted coins may not be considered part of the total pool of the entity's resources and may be utilized as a way to transact between the wallet to another wallet.

In some embodiments, the creation of new digital assets or new entity resources may be enabled by performing a fork to the original blockchain for the transaction records dividing a number of resources past a certain block. After creation of the digital wallet for the participant and approval by the necessary authorities, the wallet controller may be provided the key to access their resources.

FIG. 10 depicts a blockchain transaction process 1000 in accordance with one embodiment. A blockchain is an ever-growing set of data blocks. Each block records a collection of transactions. In some configurations, these transactions may come from a transaction requesting device 1002. Blockchains distribute these transactions across a group of computers. Each computer maintains its own copy of the blockchain transactions.

A blockchain is a continuously growing list of records, called blocks, which are linked and secured using cryptography. Each block typically comprises a cryptographic hash of the previous block, a timestamp, and transaction data. By design, a blockchain is resistant to modification of the data. Blockchains may implement an open, distributed ledger that can record transactions between two parties efficiently and in a verifiable and permanent way.

A blockchain is typically managed by multiple parties collectively adhering to a protocol for inter-node communication and validating new blocks. Once recorded, the data in any given block cannot be altered retroactively without alteration of all subsequent blocks, which requires consensus among the operators.

Cryptography involving mathematical methods of keeping data secret and proving identity is utilized when recording transactions. One digital key ensures only an owner can enter a transaction to the blockchain involving their assets, and another digital key lets other parties confirm it really was the owner who added the transaction.

Blockchain is resistant to tampering or other changes by utilizing a cryptographic technique called the hash. Hashing reduces data to a sequence of seemingly random characters—for example, the hash of the phrase “the quick brown fox” is “9ECB36561341D18EB65484E833EFEA61EDC74B84CF5E6AE1B81C63533E25FC8F” using a hash method called SHA-256. Tweaking just one letter in the phrase produces a completely different hash, and you can't go backward to figure out the original data from the hash.

With blockchain, hashes are linked together so any minute change is immediately visible, not just for the block housing it but for all other blocks added later. With red flags that big for changes that small, auditing becomes easier.

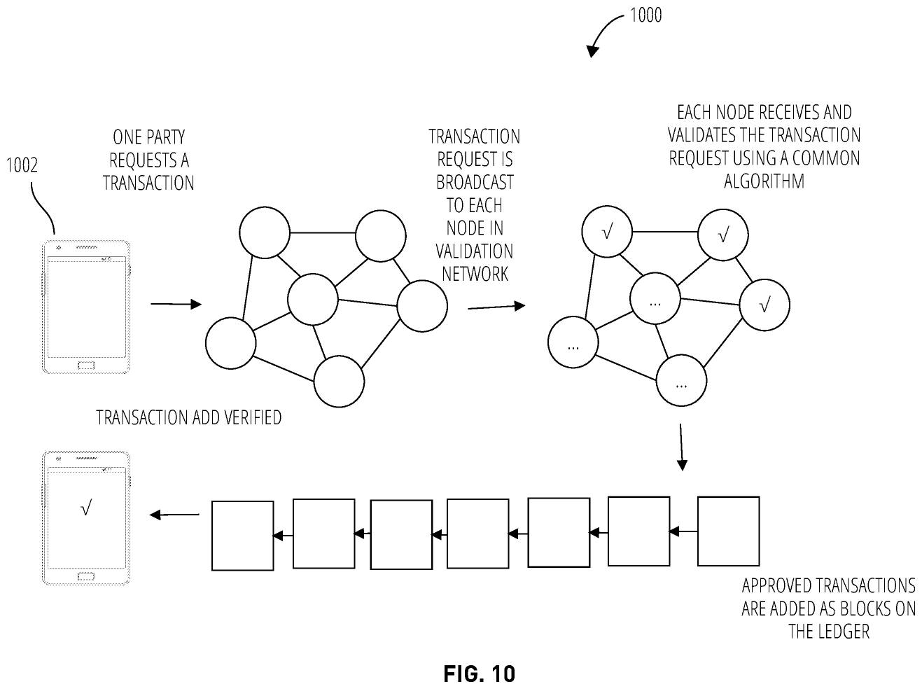

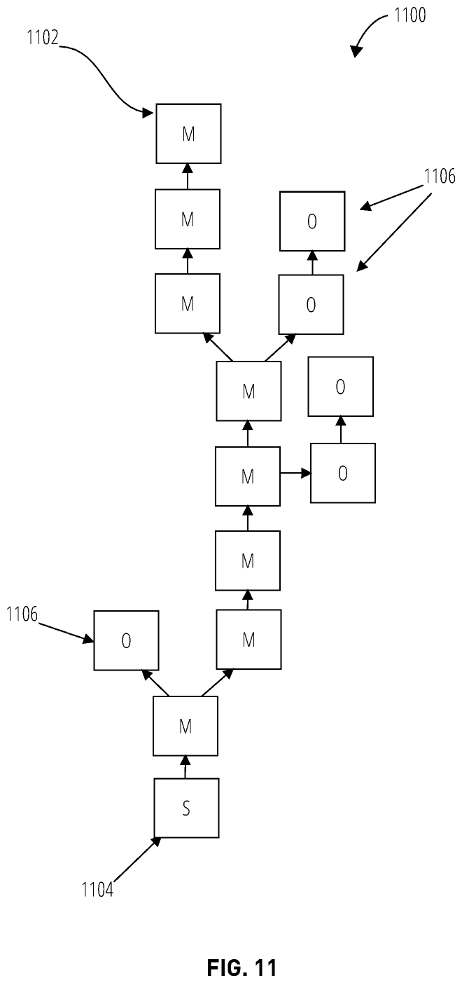

FIG. 11 depicts an exemplary blockchain formation 1100. The mainchain 1102 (M blocks) comprises the longest series of blocks from the start block 1104 (S block) to the current block. Orphan blocks 1106 (O blocks) exist outside of the main chain.

Blocks hold batches of valid transactions that are hashed and encoded, for example into a Merkle tree. Each block includes the cryptographic hash of the prior block in the blockchain formation 1100, linking the two. The linked blocks form a chain. This iterative process confirms the integrity of the previous block, all the way back to the original start block 1104.

Sometimes separate blocks can be produced concurrently, creating a temporary fork. In addition to a secure hash-based history, the blockchain formation 1100 has a specified algorithm for scoring different versions of the history so that one with a higher value can be selected over others. Blocks not selected for inclusion in the mainchain 1102 are called orphan blocks 1106. Peers supporting the blockchain formation 1100 have different versions of the history from time to time. They keep only the highest-scoring version of the blockchain formation 1100 known to them. Whenever a peer receives a higher-scoring version (usually the old version with a single new block added) they extend or overwrite their local version of the blockchain formation 1100 and retransmit the improvement to their peers. There is never an absolute guarantee that any particular entry will remain in the best version of the history forever. Because blockchains are typically built to add the score of new blocks onto old blocks and because there are incentives to work only on extending with new blocks rather than overwriting old blocks, the probability of an entry becoming superseded goes down exponentially as more blocks are built on top of it, eventually becoming very low. For example, in a blockchain using the proof-of-work system, the chain with the most cumulative proof-of-work is always considered the valid one by the network. There are a number of methods that can be used to demonstrate a sufficient level of computation. Within a blockchain the computation is carried out redundantly rather than in the traditional segregated and parallel manner.

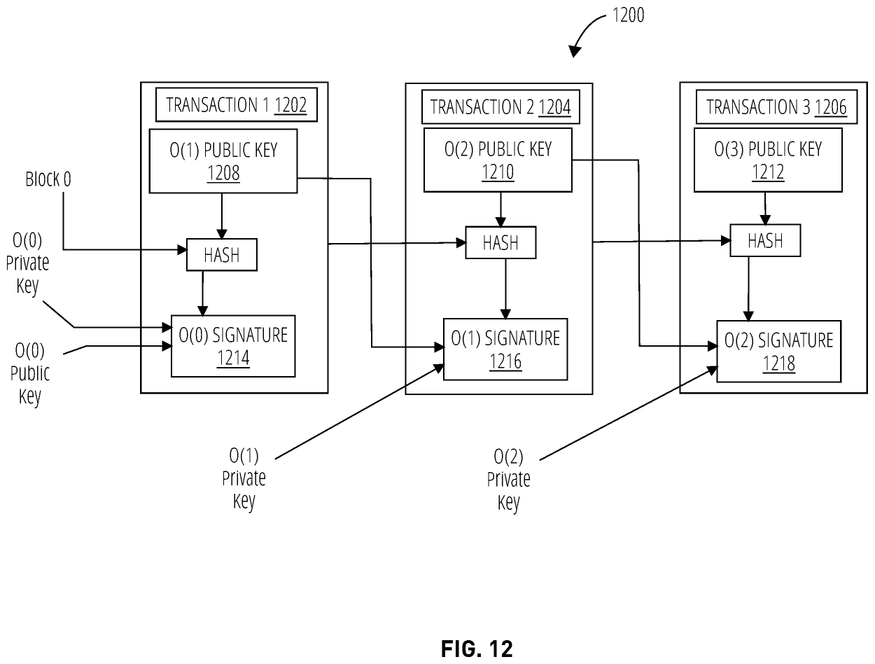

FIG. 12 depicts an embodiment of an irreversible transaction blockchain 1200. The blockchain 1200 is a sequence of digitally signed transactions (transaction 1 1202, transaction 2 1204, and transaction 3 1206 etc.). Each transaction includes the current controller's public key (block 1 owner public key 1208, block 2 owner public key 1210, and block 3 owner public key 1212 respectively) and the previous owner's signature (O(0) signature 1214, O(1) signature 1216, and O(2) signature 1218) which are generated using a hash function. The controller of a transaction can examine each previous transaction to verify the chain of control. Unlike traditional check endorsements, the transactions in the blockchain 1200 are irreversible, which mitigates fraud.

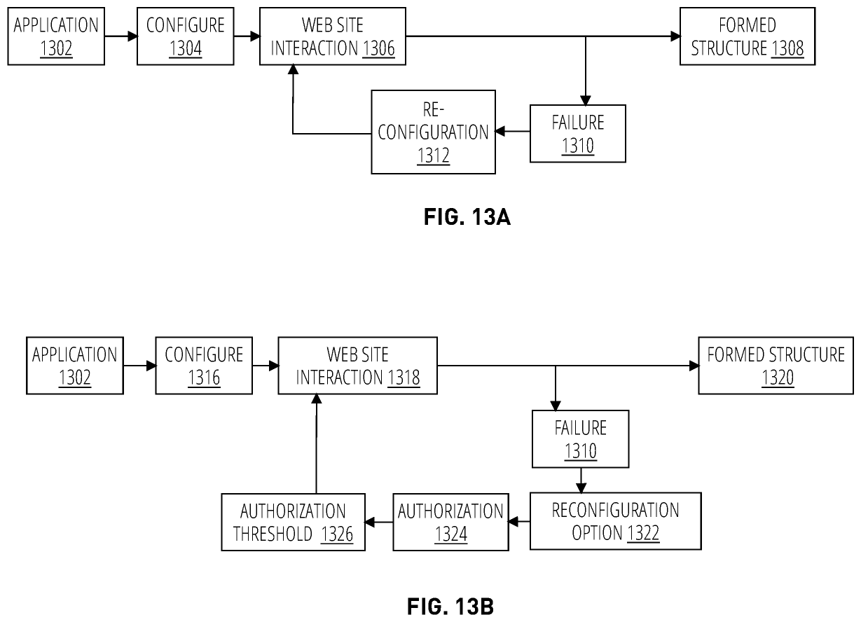

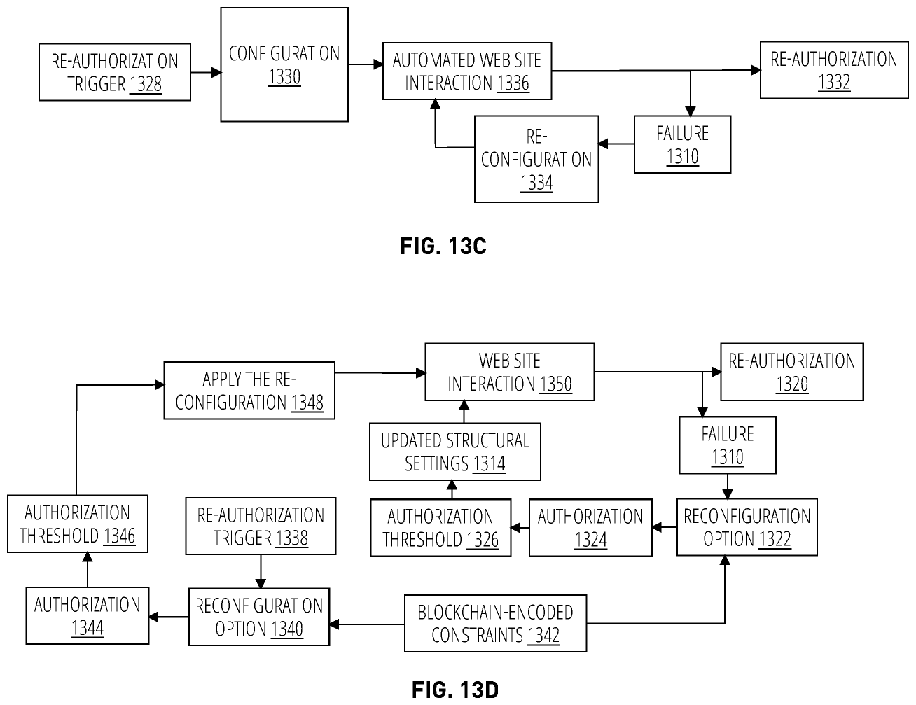

FIG. 13A-FIG. 13D depict a system and process to form cloud-based resource allocation and control structures with reduced configuration and manual interaction, in one embodiment.

Referring to FIG. 13A, an end user may activate the application 1302 to configure settings for a centralized allocation and control structure 1304. The system applies the settings to carry out a regionally-specific automated web site interaction 1306, resulting in a formed centralized structure 1308. If the automated web site interaction 1306 results in a failure 1310 due to improperly configured settings (as determined by the automated web site interaction 1306), the system initiates a re-configuration 1312 and re-attempts the automated web site interaction 1306 with updated structural settings 1314.

Referring now to FIG. 13B, the system may also be operated to configure settings for a distributed allocation and control structure 1316. The system applies the settings to carry out a regionally-specific automated web site interaction 1318 resulting in a re-authorization of the de-centralized allocation and control structure 1320. In this case a failure 1310 due to improper settings causes the system to present one or more structural reconfiguration option 1322, triggering a collection and count of structural component input authorizations 1324. If (on condition that) an authorization threshold is met 1326, the automated web site interaction 1318 is re-attempted with updated settings reflecting the authorized structural change(s).

FIG. 13C depicts system operation when a re-authorization trigger 1328 for a centralized allocation and control structure 1304 is detected. The system applies an existing (or updated) configuration 1330 of the centralized allocation and control structure 1304 to an automated web site interaction 1306, resulting in a re-authorization of the centralized control and allocation structure 1332. If the re-authorization attempt fails, a re-configuration 1334 is performed and applied to the automated web site interaction 1336.

FIG. 13D depicts system operation when a re-authorization trigger 1338 is detected for a re-authorization of the de-centralized allocation and control structure 1320. A structural reconfiguration option 1340 may be presented that meets blockchain-encoded constraints 1342 for the re-authorization of the de-centralized allocation and control structure 1320. A collection and count of structural component authorizations 1344 is carried out and on condition that an authorization threshold is met 1346, the system will apply the re-configuration 1348 to an automated web site interaction 1350 to generate a re-authorization of the de-centralized allocation and control structure 1320. A failure 1310 due to improper settings causes the system to present one or more structural reconfiguration option 1322, triggering the collection and count of structural component input authorizations 1324. If (on condition that) an authorization threshold is met 1326, the automated web site interaction 1350 is re-attempted with updated structural settings 1314 reflecting the authorized structural change(s).

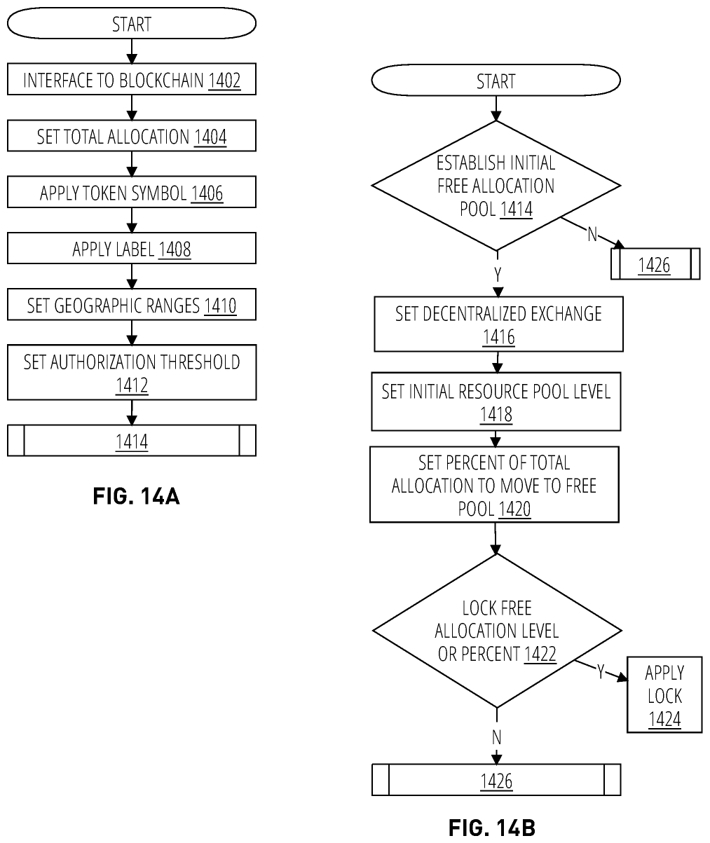

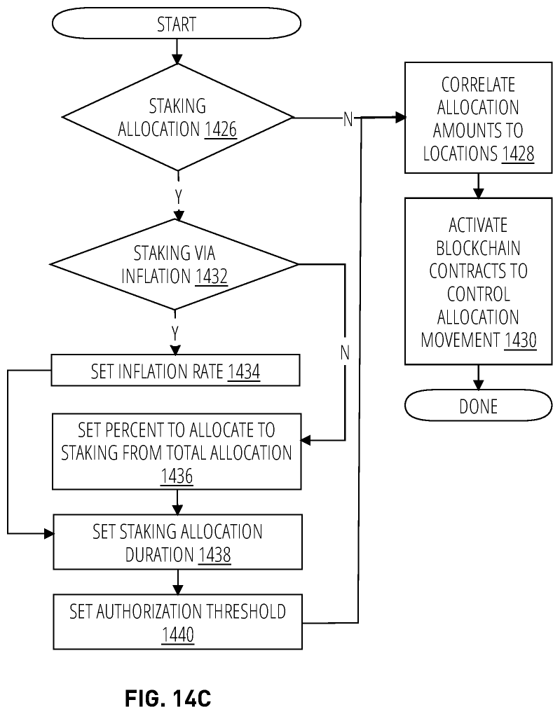

FIG. 14A-FIG. 14C depict a process for configuration and operation of a de-centralized resource allocation and control structure. In block 1402, an interface is established to one or more blockchains. In block 1404, a total resource allocation is configured into the structure. In block 1406, block 1408, and block 1410, a token symbol, label, and geographic ranges are configured, respectively. In block 1412, an authorization threshold is set for the structure and/or changes to the structure.

After this initial configuration, allocations are configured as are constraints and conditions for re-allocations and allocation level adjustments. If the system will comprise an initial free allocation pool, operation proceeds from decision block 1414 to establishing a de-centralized exchange (block 1416). An initial resource pool level is established at block 1418 and a percent of the total allocation to move to the free pool is set at block 1420. If the free allocation is to be locked at a certain level or percent (decision block 1422), the lock is applied at block 1424.

Conditional on whether the system is to include a staking allocation (decision block 1426), the allocation is configured either as a scaling factor or automatic increment (e.g., an “inflation” stake, decision block 1432 and block 1434) or as a percentage of the total allocation (block 1436). The duration of any staking allocations and an authorization threshold for allocations/changes is set (block 1438 and block 1440, respectively). The allocations are correlated to locations (block 1428) and the blockchain contracts are activated (block 1430) to control allocation changes and movements between controllers.

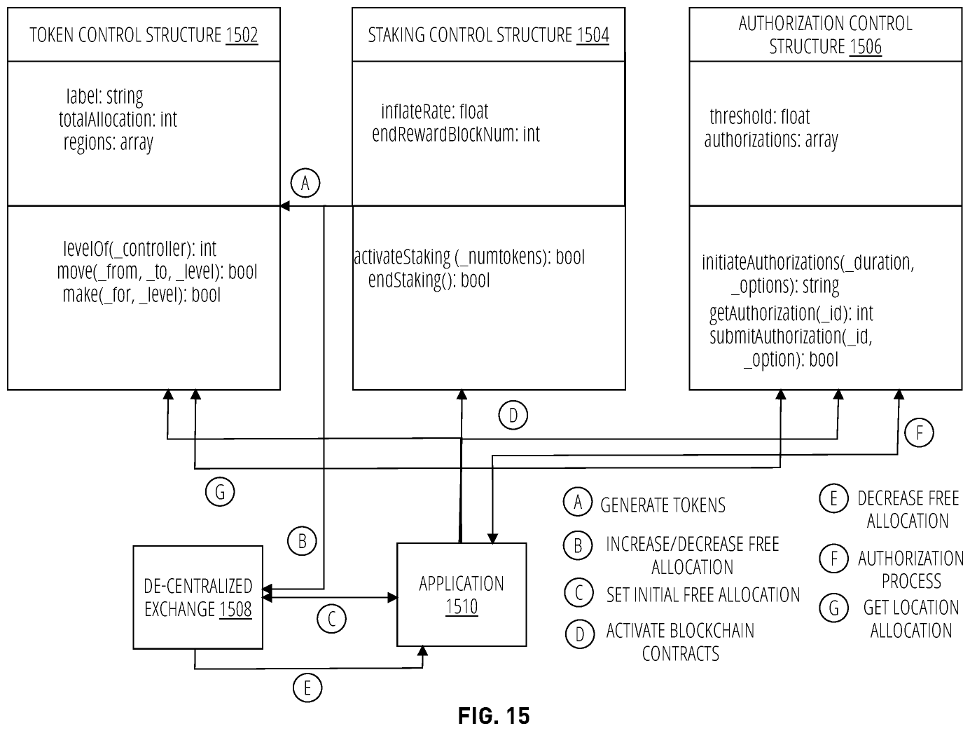

FIG. 15 depicts components of an allocation and transfer control system in one embodiment. The system comprises a token control structure 1502, a staking control structure 1504, an authorization control structure 1506, a de-centralized exchange 1508, and an application 1510 that drives and coordinates the operation of the other components.

The token control structure 1502 comprises configured settings for label: string, totalAllocation: int, and regions: array. The token control structure 1502 also implements operations levelOf(_controller): int, move(_from, _to, _level): bool, and make(_for, _level): bool.

The staking control structure 1504 comprises settings to configure and control staking as set forth for example in conjunction with FIG. 14A-FIG. 14C.

The authorization control structure 1506 comprises settings and functionality to perform authorizations for resource allocations and reallocations in accordance with the mechanisms disclosed herein.

The de-centralized exchange 1508 may be implemented using blockchain smart contracts and resource configuration controls to effect allocation and reallocation of entity resources in accordance with the mechanisms disclosed herein.

The application 1510 operates and coordinates the other components to implement embodiments of the processes described herein, for example in FIG. 13A-FIG. 14C.

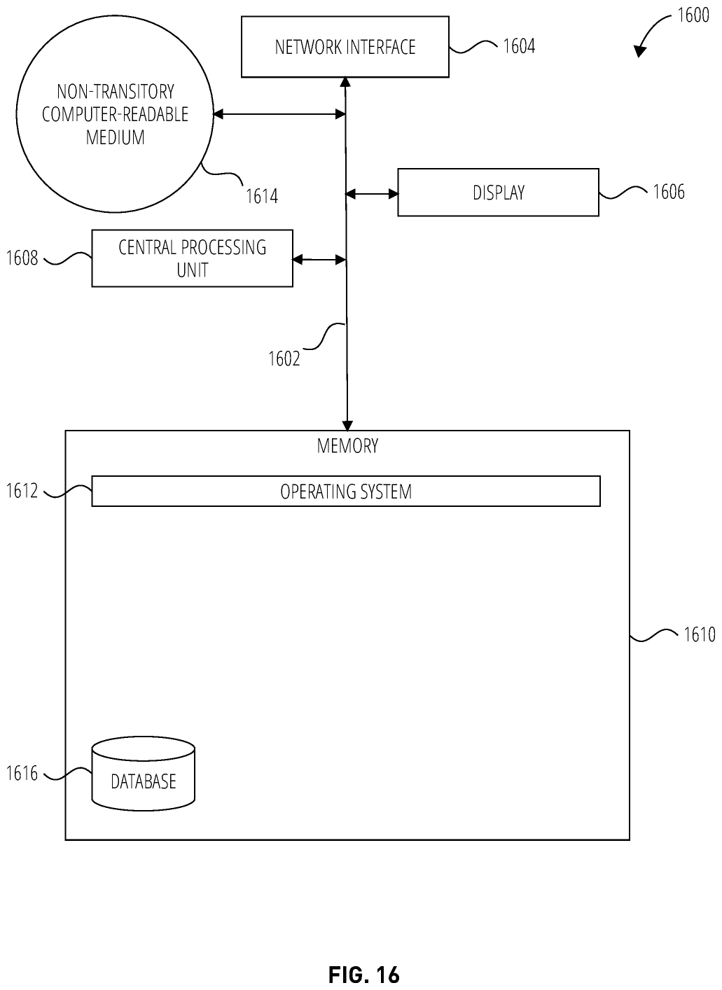

FIG. 16 depicts several components of an exemplary system 1600 in accordance with one embodiment. In various embodiments, system 1600 may include a desktop PC, server, workstation, mobile phone, laptop, tablet, set-top box, appliance, or other computing device that is capable of performing operations such as those described herein. In some embodiments, system 1600 may include many more components than those shown in FIG. 16. However, it is not necessary that all of these generally conventional components be shown in order to disclose an illustrative embodiment. Collectively, the various tangible components or a subset of the tangible components may be referred to herein as “logic” configured or adapted in a particular way, for example as logic configured or adapted with particular software or firmware.

In various embodiments, system 1600 may comprise one or more physical and/or logical devices that collectively provide the functionalities described herein. In some embodiments, system 1600 may comprise one or more replicated and/or distributed physical or logical devices.

In some embodiments, system 1600 may comprise one or more computing resources provisioned from a “cloud computing” provider, for example, Amazon Elastic Compute Cloud (“Amazon EC2”), provided by Amazon.com, Inc. of Seattle, Washington; Sun Cloud Compute Utility, provided by Sun Microsystems, Inc. of Santa Clara, California; Windows Azure, provided by Microsoft Corporation of Redmond, Washington, and the like.

System 1600 includes a bus 1602 interconnecting several components including a network interface 1604, a display 1606, a central processing unit 1608, and a memory 1610.

Memory 1610 generally comprises a random access memory (“RAM”) and permanent non-transitory mass storage device, such as a hard disk drive or solid-state drive. Memory 1610 stores an operating system 1612.

These and other software components may be loaded into memory 1610 of system 1600 using a drive mechanism (not shown) associated with a non-transitory computer-readable medium 1614, such as a DVD/CD-ROM drive, memory card, network download, or the like.

Memory 1610 also includes database 1616. In some embodiments, system 1600 may communicate with database 1616 via network interface 1604, a storage area network (“SAN”), a high-speed serial bus, and/or via the other suitable communication technology.

In some embodiments, database 1616 may comprise one or more storage resources provisioned from a “cloud storage” provider, for example, Amazon Simple Storage service (“Amazon S3”), provided by Amazon.com, Inc. of Seattle, Washington, Google Cloud Storage, provided by Google, Inc. of Mountain View, California, and the like.

Terms used herein should be accorded their ordinary meaning in the relevant arts, or the meaning indicated by their use in context, but if an express definition is provided, that meaning controls.

“Circuitry” in this context refers to electrical circuitry having at least one discrete electrical circuit, electrical circuitry having at least one integrated circuit, electrical circuitry having at least one application specific integrated circuit, circuitry forming a general purpose computing device configured by a computer program (e.g., a general purpose computer configured by a computer program which at least partially carries out processes or devices described herein, or a microprocessor configured by a computer program which at least partially carries out processes or devices described herein), circuitry forming a memory device (e.g., forms of random access memory), or circuitry forming a communications device (e.g., a modem, communications switch, or optical-electrical equipment).

“Firmware” in this context refers to software logic embodied as processor-executable instructions stored in read-only memories or media.

“Hardware” in this context refers to logic embodied as analog or digital circuitry.

“Logic” in this context refers to machine memory circuits, non transitory machine readable media, and/or circuitry which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter).

“Software” in this context refers to logic implemented as processor-executable instructions in a machine memory (e.g. read/write volatile or nonvolatile memory or media).

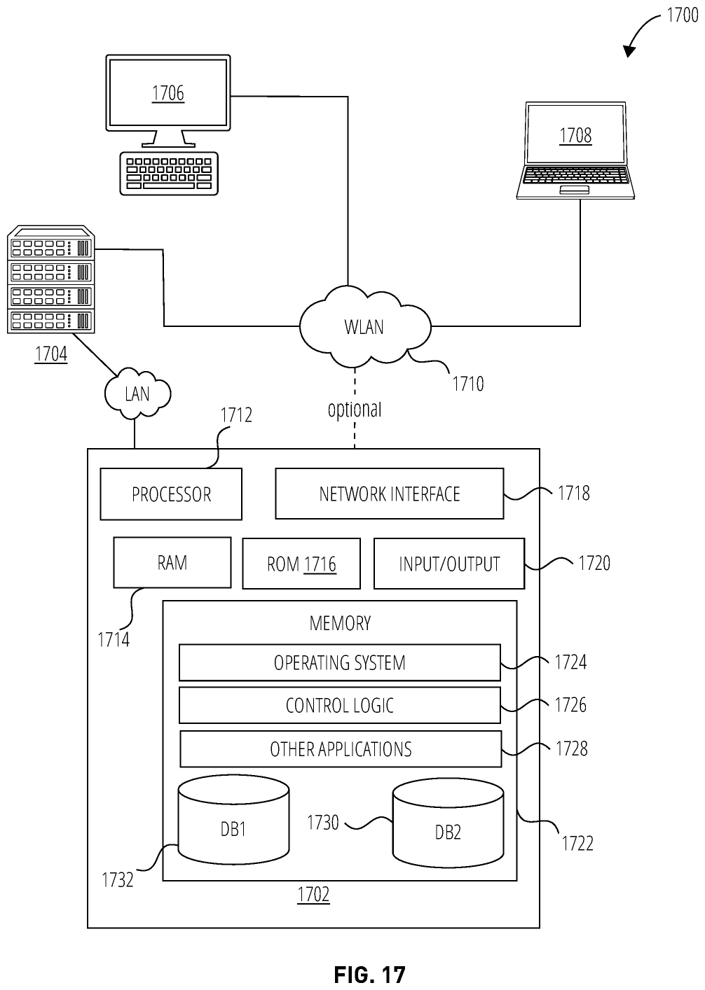

FIG. 17 depicts one example of a system architecture and data processing device that may be used to implement one or more illustrative aspects described herein in a standalone and/or networked environment. Various network nodes including data server 1702, web server 1704, computer 1706, and laptop 1708 may be interconnected via a wide area network 1710 (WAN), such as the internet. Other networks may also or alternatively be used, including private intranets, corporate networks, LANs, metropolitan area networks (MANs) wireless networks, personal networks (PANs), and the like. Network 1710 is for illustration purposes and may be replaced with fewer or additional computer networks. A local area network (LAN) may have one or more of any known LAN topology and may use one or more of a variety of different protocols, such as ethernet. Devices including data server 1702, web server 1704, computer 1706, laptop 1708 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components in the illustrative computer system architecture 1700 may include data server 1702, web server 1704, and client computer 1706, laptop 1708. Data server 1702 provides overall access, control and administration of databases and control software for performing one or more illustrative aspects described herein. Data server 1702 may be connected to web server 1704 through which users interact with and obtain data as requested. Alternatively, data server 1702 may act as a web server itself and be directly connected to the internet. Data server 1702 may be connected to web server 1704 through the network 1710 (e.g., the internet), via direct or indirect connection, or via some other network. Users may interact with the data server 1702 using remote computer 1706, laptop 1708, e.g., using a web browser to connect to the data server 1702 via one or more externally exposed web sites hosted by web server 1704. Client computer 1706, laptop 1708 may be used in concert with data server 1702 to access data stored therein, or may be used for other purposes. For example, from client computer 1706, a user may access web server 1704 using an internet browser, as is known in the art, or by executing a software application that communicates with web server 1704 and/or data server 1702 over a computer network (such as the internet).

Servers and applications may be combined on the same physical machines, and retain separate virtual or logical addresses, or may reside on separate physical machines. FIG. 17 depicts just one example of a network architecture that may be used, and those of skill in the art will appreciate that the specific network architecture and data processing devices used may vary, and are secondary to the functionality that they provide, as further described herein. For example, services provided by web server 1704 and data server 1702 may be combined on a single server.

Each component including data server 1702, web server 1704, computer 1706, laptop 1708 may be any type of known computer, server, or data processing device. Data server 1702, e.g., may include a processor 1712 controlling overall operation of the data server 1702. Data server 1702 may further include RAM 1714, ROM 1716, network interface 1718, input/output interfaces 1720 (e.g., keyboard, mouse, display, printer, etc.), and memory 1722. Input/output interfaces 1720 may include a variety of interface units and drives for reading, writing, displaying, and/or printing data or files. Memory 1722 may further store operating system software 1724 for controlling overall operation of the data server 1702, control logic 1726 for instructing data server 1410 to perform aspects described herein, and other application software 1728 providing secondary, support, and/or other functionality which may or may not be used in conjunction with aspects described herein. The control logic may also be referred to herein as the data server software control logic 1726. Functionality of the data server software may refer to operations or decisions made automatically based on rules coded into the control logic, made manually by a user providing input into the system, and/or a combination of automatic processing based on user input (e.g., queries, data updates, etc.).

Memory 1722 may also store data used in performance of one or more aspects described herein, including a first database 1730 and a second database 1732. In some embodiments, the first database may include the second database (e.g., as a separate table, report, etc.). That is, the information can be stored in a single database, or separated into different logical, virtual, or physical databases, depending on system design. Web server 1704, computer 1706, laptop 1708 may have similar or different architecture as described with respect to data server 1702. Those of skill in the art will appreciate that the functionality of data server 1702 (or web server 1704, computer 1706, laptop 1708) as described herein may be spread across multiple data processing devices, for example, to distribute processing load across multiple computers, to segregate transactions based on geographic location, user access level, quality of service (QoS), etc.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionalities may be embodied in whole or in part in software, firmware and/or hardware or hardware equivalents such as integrated circuits, field programmable gate arrays (FPGA), and the like. Particular data structures may be used to more effectively implement one or more aspects described herein, and such data structures are contemplated within the scope of computer executable instructions and computer-usable data described herein.

LISTING OF DRAWING ELEMENTS
100 resource allocation and transfer control system
102 browser
104 database
106 domain API
108 unified website API
110 API monitor
112 crawler
114 IP and proxy manager
116 headless browser
118 internal tools
120 domain
122 dashboard
124 task queue
126 core API
128 structured display
130 queues tasks
132 request
134 domain-specific transform
136 validator
138 cloud computing system
140 error check and validation
142 websites
144 update control
146 formation control structure
148 success control
150 change detected control
200 resource allocation and transfer control system
202 user interface
204 distributed ledger
206 resource configuration control
208 resource transfer activity
210 entity resources
212 individual
214 individual
216 gateway nodes
218 blockchain
220 entity records
222 oracle service
224 transfer requirements
226 resource transfer record
300 method
302 block
304 block
306 block
308 block
310 block
400 resource allocation and transfer control system
402 user interface
404 configuration and control system
406 distributed ledger
408 block submission service
410 oracle service
412 participants
414 resource configuration control
416 individual
418 entity
420 management authority
422 multi-signature wallet
424 first party keypair
426 API
428 multi-signature wallet
430 entity keypair
432 entity member
434 entity resources
436 manager
438 multi-signature wallet
440 authorization authority keypair
442 transfer request
444 approval request
446 confirmation
448 confirmation
450 confirmation
452 resource transfer record
454 resource transfer
500 resource allocation and transfer control system
502 block submission service
504 distributed ledger
506 entity
508 authorization authority
510 user allocation
512 user allocation
514 entity resources
516 multi-signature wallet
518 keypair
520 transfer request
522 multi-signature wallet
524 multi-signature wallet
526 multi-signature wallet
528 keypair
530 transfer request
532 at least one entity member
534 entity keypair
536 authorize the transaction
538 confirmation
540 at least one entity authorization authority
542 resource transfer
544 authorization authority keypair
546 confirmation
548 confirmation
550 confirmation
552 resource transfer record
600 resource allocation and transfer control system
602 block submission service
604 distributed ledger
606 entity
608 authorization authority
610 user allocation
612 user allocation
614 entity resources
616 multi-signature wallet
618 keypair
620 transfer request
622 multi-signature wallet
624 multi-signature wallet
626 multi-signature wallet
628 keypair
630 transfer request
632 at least one entity member
634 entity keypair
636 authorize the transaction
638 confirmation
640 confirmation
642 confirmation
644 at least one entity authorization authority
646 authorization authority keypair
648 rejection
700 resource allocation and transfer control system
702 block submission service
704 distributed ledger
706 entity
708 authorization authority
710 user allocation
712 user allocation
714 entity resources
716 multi-signature wallet
718 keypair
720 transfer request
722 multi-signature wallet
724 multi-signature wallet
726 multi-signature wallet
728 keypair
730 transfer request
732 at least one entity member
734 entity keypair
736 authorize the transaction
738 confirmation
740 at least one entity authorization authority
742 transfer information
744 third party services
746 authorization authority keypair
748 resource transfer
750 confirmation
752 confirmation
754 confirmation
756 resource transfer record
800 resource allocation and transfer control system
802 system formation and management system
804 participants
806 authorization authority
808 user allocations
810 entity
812 at least one entity authorization authority
814 multi-signature wallet
816 authorization authority keypair
818 multi-signature wallet
820 keypair
822 at least one entity member
824 multi-signature wallet
826 entity keypair
828 transfer authentication configuration
830 new entity authorization authority
832 multi-signature wallet
834 new authorization authority keypair
836 transfer requirements
900 resource allocation and transfer control system
902 system formation and management system
904 block submission service
906 distributed ledger
908 participants
910 entity
912 authorization authority
914 user allocation
916 at least one entity member
918 multi-signature wallet
920 at least one entity authorization authority
922 multi-signature wallet
924 multi-signature wallet
926 entity resource configuration
928 new resource multi-signature wallet
930 entity keypair
932 new resource multi-signature wallet
934 authorization authority keypair
936 new resource multi-signature wallet
938 user keypair
940 new digital assets
942 transfer request
944 authorize the transaction
946 authorize the transaction
948 new resource transfer
950 new digital assets
952 authorize the transaction
954 resource transfer record
1000 blockchain transaction process
1002 transaction requesting device
1100 blockchain formation
1102 mainchain
1104 start block
1106 orphan blocks
1200 blockchain
1202 transaction 1
1204 transaction 2
1206 transaction 3
1208 block 1 owner public key
1210 block 2 owner public key
1212 block 3 owner public key
1214 O(0) signature
1216 O(1) signature
1218 O(2) signature
1302 activate the application
1304 centralized allocation and control structure
1306 automated web site interaction
1308 formed centralized structure
1310 failure
1312 re-configuration
1314 updated structural settings
1316 distributed allocation and control structure
1318 automated web site interaction
1320 re-authorization of the de-centralized allocation and control structure
1322 structural reconfiguration option
1324 collection and count of structural component input authorizations
1326 authorization threshold is met
1328 re-authorization trigger
1330 configuration
1332 re-authorization of the centralized control and allocation structure
1334 re-configuration
1336 automated web site interaction
1338 re-authorization trigger
1340 structural reconfiguration option
1342 blockchain-encoded constraints
1344 collection and count of structural component authorizations
1346 authorization threshold is met
1348 apply the re-configuration
1350 automated web site interaction
1402 block
1404 block
1406 block
1408 block
1410 block
1412 block
1414 decision block
1416 block
1418 block
1420 block
1422 decision block
1424 block
1426 decision block
1428 block
1430 block
1432 decision block
1434 block
1436 block
1438 block
1440 block
1502 token control structure
1504 staking control structure
1506 authorization control structure
1508 de-centralized exchange
1510 application
1600 system
1602 bus
1604 network interface
1606 display
1608 central processing unit
1610 memory
1612 operating system
1614 non-transitory computer-readable medium
1616 database
1700 illustrative computer system architecture
1702 data server
1704 web server
1706 computer
1708 laptop
1710 network
1712 processor
1714 RAM
1716 ROM
1718 network interface
1720 input/output interfaces
1722 memory
1724 operating system software
1726 control logic
1728 other application software
1730 first database
1732 second database

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “secondregister” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

Having thus described illustrative embodiments in detail, it will be apparent that modifications and variations are possible without departing from the scope of the invention as claimed. The scope of inventive subject matter is not limited to the depicted embodiments but is rather set forth in the following Claims.

What is claimed is:

1. A method comprising:
receiving a resource configuration control at an entity formation and management system by way of a user interface, wherein the entity formation and management system includes settings defining a resource allocation structure of an entity, and where the resource configuration control comprises settings to create or change the resource allocation structure of the entity;
configuring at least one blockchain comprising a plurality of gateway nodes to record resource transfer activity comprising resource rights allocation between the entity and one or more parties in the at least one blockchain as entity records, wherein the at least one blockchain comprises digital assets representing entity resources;
communicating settings of the resource configuration control to an oracle service to verify resource transfer requirements for each resource rights allocation, the resource transfer requirements encoded as constraints on the at least one blockchain;
transferring entity resources between the entity and the one or more parties in response to the oracle service verifying that the resource transfer requirements were met; and
writing a resource transfer record into the at least one blockchain in response to the oracle service verifying that the resource transfer requirements were met.

2. The method of claim 1, further comprising:
applying a reconfiguration control for the resource structure of the entity to a website interface;
receiving from the website a failure indication for the reconfiguration control;
applying constraints encoded on the blockchain to generate a new reconfiguration control comprising updated structural settings for the resource configuration control; and
operating a feedback loop to apply the reconfiguration control between the entity formation and management system and the website interface.

3. The method of claim 2, wherein operating the feedback loop comprises execution of a multi-party authorization defined by the resource transfer requirements encoded as constraints on the at least one blockchain.

4. The method of claim 2, the resource configuration control comprising:
settings to establish a total resource allocation;
settings to establish an initial free resource allocation pool from among the total resource allocation; and
settings to establish geographic ranges on resource allocations from among one or both of the total resource allocation or the free resource allocation pool.

5. The method of claim 1, further comprising configuring a first multi-signature wallet to accept keypairs, wherein the first multi-signature wallet requires approval from N-keypairs out of M-keypairs to transfer the entity resources to a first party and to write the resource transfer record into the at least one blockchain.

6. The method of claim 5, wherein:
the first party is granted X first party (FP)-keypairs out of M-keypairs;
the entity is granted Y entity-keypairs out of M-keypairs; and
an authorization authority is granted Z authorization authority (BA)-keypairs out of M-keypairs,
wherein a total number of M-keypairs equals X+Y+Z, and the authorization authority is part of the entity.

7. The method of claim 6, wherein the N-keypairs must include at least one entity-keypair and at least one BA-keypair.

8. The method of claim 6, wherein the N-keypairs do not include any FP-keypairs.

9. The method of claim 2 further comprising transferring new entity resources by:
granting a first party and the entity a multi-signature wallet configured to accept keypairs, wherein the multi-signature wallet requires approval from N-keypairs out of M-keypairs to transfer the entity resources or new entity resources to the first party, or to write the resource transfer record into the blockchain;
filling a new resource multisignature wallet with new digital assets; and
transferring the new digital assets to the first party,
wherein the new digital assets in the new resource multisignature wallet are used to transfer the new entity resources from the new resource multisignature wallet to the first party multi-signature wallet,
wherein a total number of new digital assets in the new resource multisignature wallet is reduced by a total number of new entity resources transferred.

10. The method of claim 9, further comprising the updating the entity digital assets in the at least one blockchain to reflect a new resource distribution.

11. The method of claim 9, wherein the new digital assets are not part of the entity digital assets in the blockchain.

12. An resource allocation and management system comprising:
at least one processor; and
at least one memory comprising instructions that, when executed by the at least one processor, cause the system to:
define a resource allocation structure of an entity;
configure at least one blockchain comprising a plurality of gateway nodes to record resource transfer activity comprising resource rights allocation between the entity and one or more parties in the at least one blockchain as entity records, wherein the at least one blockchain comprises digital assets representing entity resources;
communicate settings of the resource configuration control to an oracle service to verify resource transfer requirements for each resource rights allocation, the resource transfer requirements encoded as constraints on the at least one blockchain;
transfer entity resources between the entity and the one or more parties in response to the oracle service verifying that the resource transfer requirements were met;
write a resource transfer record into the at least one blockchain in response to the oracle service verifying that the resource transfer requirements were met;
apply a reconfiguration control for the resource structure of the entity to a website interface;
receive from the website a failure indication for the reconfiguration control;
apply constraints encoded on the blockchain to generate a new reconfiguration control comprising updated structural settings for the resource configuration control; and
operate a feedback loop to apply the reconfiguration control between the entity formation and management system and the website interface.

13. The system of claim 12, wherein operating the feedback loop comprises execution of a multi-party authorization defined by the resource transfer requirements encoded as constraints on the at least one blockchain.

14. The system of claim 12, the resource configuration control comprising:
settings to establish a total resource allocation;
settings to establish an initial free resource allocation pool from among the total resource allocation; and
settings to establish geographic ranges on resource allocations from among one or both of the total resource allocation or the free resource allocation pool.

15. The system of claim 12, further comprising:
a first multi-signature wallet to accept keypairs, wherein the first multi-signature wallet requires approval from N-keypairs out of M-keypairs to transfer the entity resources to a first party and to write the resource transfer record into the at least one blockchain.

16. The system of claim 15, wherein:
the first party is granted X first party (FP)-keypairs out of M-keypairs;
the entity is granted Y entity-keypairs out of M-keypairs; and
an authorization authority is granted Z authorization authority (BA)-keypairs out of M-keypairs,
wherein a total number of M-keypairs equals X+Y+Z, and the authorization authority is part of the entity.

17. The system of claim 16, wherein the N-keypairs must include at least one entity-keypair and at least one BA-keypair.

18. The system of claim 16, wherein the N-keypairs do not include any FP-keypairs.

19. The system of claim 12, further comprising instructions that when executed cause the transfer of new entity resources by:
granting a first party and the entity a multi-signature wallet configured to accept keypairs, wherein the multi-signature wallet requires approval from N-keypairs out of M-keypairs to transfer the entity resources or new entity resources to the first party, or to write the resource transfer record into the blockchain;
filling a new resource multisignature wallet with new digital assets; and
transferring the new digital assets to the first party,
wherein the new digital assets in the new resource multisignature wallet are used to transfer the new entity resources from the new resource multisignature wallet to the first party multi-signature wallet,
wherein a total number of new digital assets in the new resource multisignature wallet is reduced by a total number of new entity resources transferred.

20. The system of claim 19, further comprising instructions that when executed cause an update the entity digital assets in the at least one blockchain to reflect a new resource distribution.
